(19) United States
(12) Patent Application Publication
(10) Pub. No.: US 2016/0132179 A1
(43) Pub. Date: May 12, 2016

(54) Three Dimensional Object Manipulation Through A Flexible Display Device

(71) Applicant: INTERNATIONAL BUSINESS MACHINES CORPORATION, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 14/538,307

(22) Filed: Nov. 11, 2014

(51) Int. Cl. G06F 3/041; G09G 5/00; G06T 3/00; G06T 19/20

(52) U.S. Cl. CPC G06F 3/0418; G06T 19/20; G09G 5/003; G06T 3/0093; G09G 2380/02

(57) ABSTRACT

Manipulating a 3D object displayed on a display device having a plurality of sensors for sensing touching and distortion of the display device and a computer coupled to the plurality of sensors. The computer detects a selection of a specified area of the digital representation of a 3D object displayed on the display device through the plurality of sensors, determines X and Y coordinates of the selected specified area of the digital representation, aligns the axes of the display device with the X and Y coordinates of the selected specified area, receives a rotation speed from the user; calculates a virtual centrifugal force associated with the sensed rotation speed, applies the virtual centrifugal force as a distortion to the selected specified area of the 3D object; and re-renders the 3D object on the display device.

### BACKGROUND

The present invention relates to flexible display devices, and more specifically to three dimensional (3D) digital object manipulation through a flexible display device.

To modify a digital representation of a 3D object requires interaction with the object in an abstract form, such as a keyboard, stylus, or mouse pointer. The keyboard, stylus or mouse does not permit physical adjustments of bending and twisting of a digital 3D image.

### SUMMARY

According to one embodiment of the present invention, a method for manipulating a three dimensional object displayed on a display device having a plurality of sensors for sensing touching and distortion of the display device and a computer coupled to the plurality of sensors. The method comprises the steps of: the computer detecting a selection of a specified area of the digital representation of a three dimensional object displayed on the display device through the plurality of sensors; the computer determining X and Y coordinates of the selected specified area of the digital representation; the computer aligning the axes of the display device with the X and Y coordinates of the selected specified area; the computer receiving a rotation speed from a user; the computer calculating a virtual centrifugal force associated with the received rotation speed; the computer applying the virtual centrifugal force as a distortion to the selected specified area of the three dimensional object; and the computer re-rendering the three dimensional object on the display device.

According to another embodiment of the present invention, a computer program product for manipulating a three dimensional object displayed on a display device having a plurality of sensors for sensing touching and distortion of the display device. The display device having a computer coupled to the plurality of sensors comprising at least one processor, one or more memories, one or more computer readable storage media. The computer program product comprises a computer readable storage medium having program instructions embodied therewith, the program instructions executable by the computer to perform a method. The method comprising: detecting, by the computer, a selection of a specified area of the digital representation of a three dimensional object displayed on the display device through the plurality of sensors; determining, by the computer, X and Y coordinates of the selected specified area of the digital representation; aligning, by the computer, the axes of the display device with the X and Y coordinates of the selected specified area; receiving, by the computer, a rotation speed from a user; calculating, by the computer, a virtual centrifugal force associated with the received rotation speed; applying, by the computer, the virtual centrifugal force as a distortion to the selected specified area of the three dimensional object; and re-rendering, by the computer, the three dimensional object on the display device.

According to another embodiment of the present invention, a computer system for manipulating a three dimensional object displayed on a display device having a plurality of sensors for sensing touching and distortion of the display device and a computer system. The computer system includes a computer coupled to the plurality of sensors comprising at least one processor, one or more memories, one or more computer readable storage media having program instructions executable by the computer to perform the program instructions. The computer program instructions comprising: determining, by the computer, X and Y coordinates of the selected specified area of the digital representation; aligning, by the computer, the axes of the display device with the X and Y coordinates of the selected specified area; receiving, by the computer, a rotation speed by a user, calculating, by the computer, a virtual centrifugal force associated with the received rotation speed; applying, by the computer, the virtual centrifugal force as a distortion to the selected specified area of the three dimensional object; and re-rendering, by the computer, the three dimensional object on the display device.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a diagram of a digital representation of a 3D object present on a display with an axis of an area of focus identified.

FIGS. 3A-3C show a diagram of a digital representation of a 3D object present on a display with the display bent in the Y axis.

FIGS. 4A-4B show a flow diagram of a method of bending a digital representation of a 3D object on a display based on a user selected area of focus.

FIG. 5 illustrates internal and external components of a client or device computer and a server computer in which illustrative embodiments may be implemented.

### DETAILED DESCRIPTION

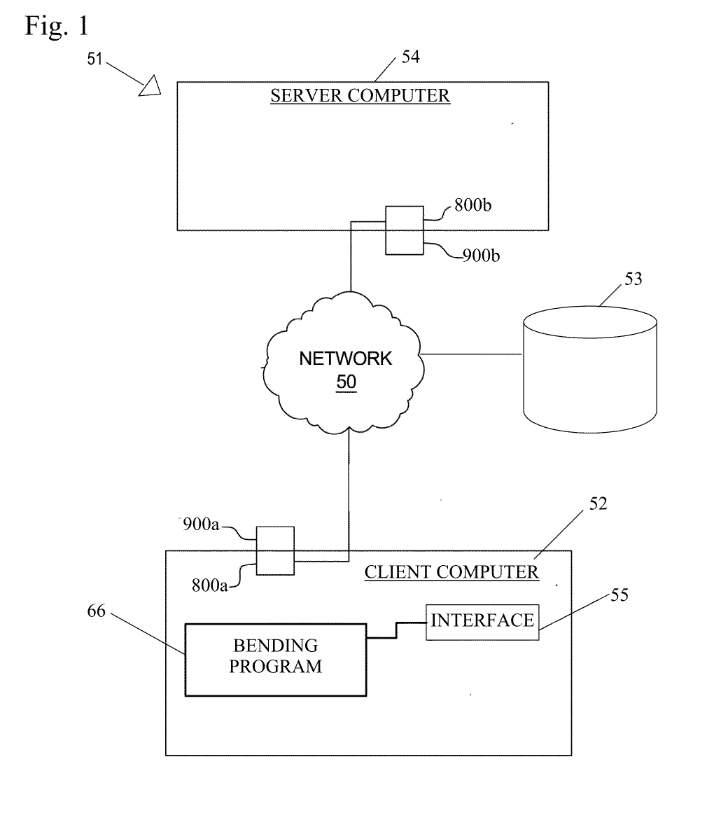

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. In other exemplary embodiments, network data processing system 51 may include additional client or device computers, storage devices or repositories, server computers, and other devices not shown.

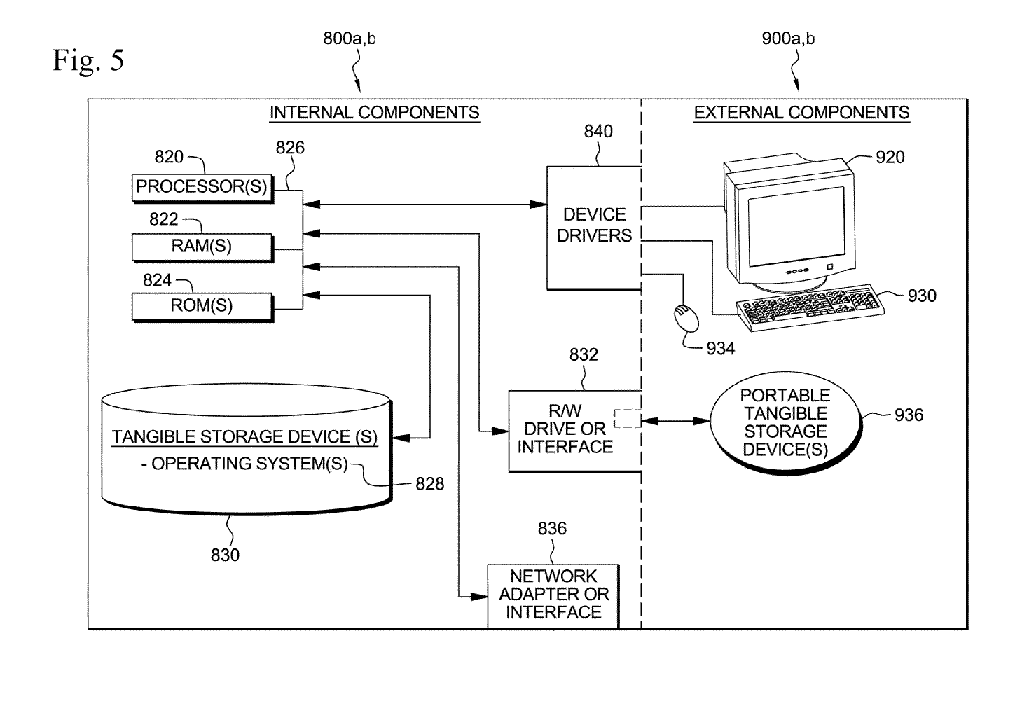

Device computer 52 includes a set of internal components 800a and a set of external components 900a, further illustrated in FIG. 5. Device computer 52 may be, for example, a mobile device, a cell phone, a personal digital assistant, a netbook, a laptop computer, a tablet computer, a desktop computer, or any other type of computing device with a flexible display.

Device computer 52 may contain an interface 55. The interface 55 may accept commands and data entry from a user. The interface 55 can be, for example, a command line interface, a graphical user interface (GUI), or a web user interface (WUI), tactile interface with pressure sensitivity. The device computer 52 preferably includes a bending program 66. While not shown, it may be desirable to have the bending program 66 be present on the server computer 54.

Server computer 54 includes a set of internal components 800b and a set of external components 900b illustrated in FIG. 5.

In the depicted example, server computer 54 provides information, such as boot files, operating system images, and applications to device computer 52. Server computer 54 can compute the information locally or extract the information from other computers on network 50.

Program code and programs such as a bending program 66 may be stored on at least one of one or more computer-readable tangible storage devices 830 shown in FIG. 5, on at least one of one or more portable computer-readable tangible storage devices 936 as shown in FIG. 5, on repository 53 connected to network 50, or downloaded to a data processing system or other device for use. For example, program code and programs such as a bending program 66 may be stored on at least one of one or more tangible storage devices 830 on server computer 54 and downloaded to the device computer 52. Alternatively, server computer 54 can be a web server, and the program code and programs such as a bending program 66 may be stored on at least one of the one or more tangible storage devices 830 on server computer 54 and accessed on the device computer 52. Bending program 66 can be accessed on device computer 52 through interface 55. In other exemplary embodiments, the program code and programs such as a bending program 66 may be stored on at least one of one or more computer-readable tangible storage devices 830 on server computer 54 or distributed between two or more servers.

A flexible display 102, a display which is flexible in nature, includes a plurality of sensors that can sense the bending direction of the display relative to axes of the display, the degree of bending of the display (bending stress imparted to the display) and touch or pressure from a user. The flexible display 102 can display a 3D digital representation of an object 104.

A user can retrieve a three dimensional (3D) object 104 from a repository, for example repository 53, to display on the flexible display 102.

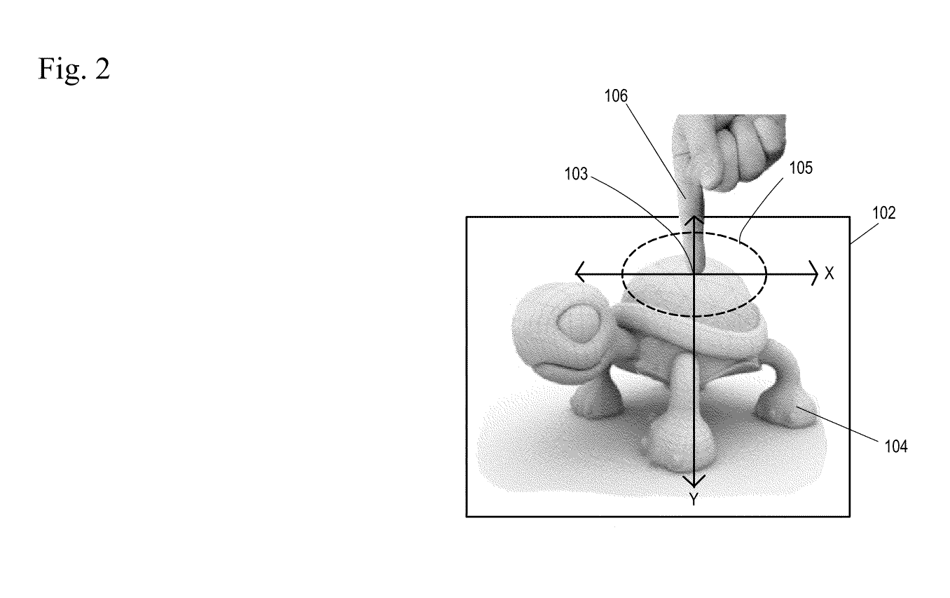

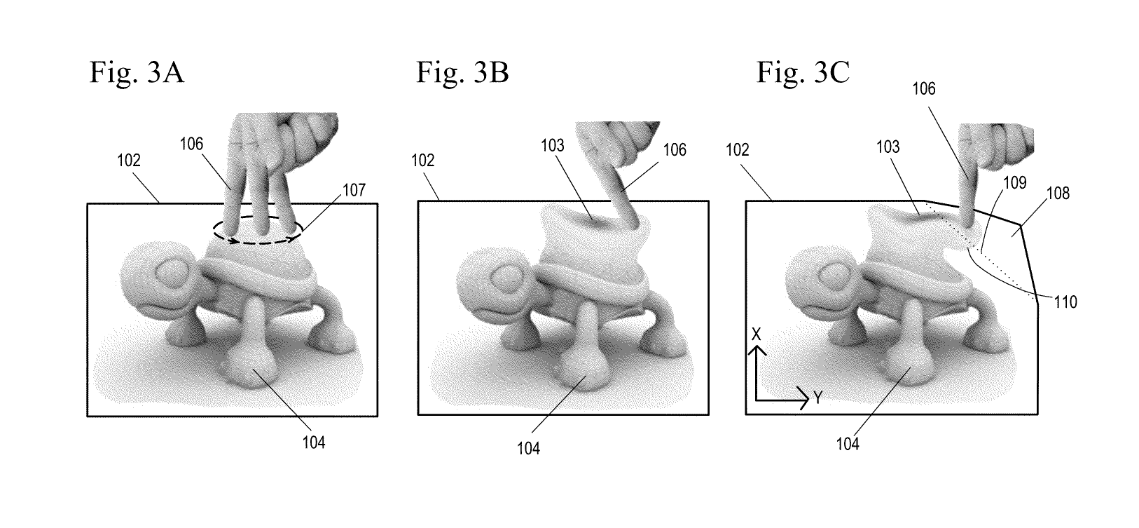

The user selects a specific area of the 3D object to focus on. The selection of the specific area 105 is preferably through touch of an interface of the flexible display 102 of a device, although other means may be used, such as a stylus. X and Y coordinates of the center of the selected area are calculated, for example by the bending program, as shown in FIG. 2. The point 103 in which the X and Y axes cross is the center of the specific area 105 in which the user has selected to focus on. The amount of area surrounding the point 103 may vary in size. The specific area of focus is a point or portion of the 3D digital image which is to be twisted, bent, or rotated and is selected by a user. The X and Y axes of the selected area are aligned with axes of the flexible display, for example the axes shown in FIG. 3C.

As shown in FIGS. 3A-3C, the user then bends and/or manipulates the flexible display 102. The manipulation can also include alteration of the specific area through centrifugal force applied to the interface of the flexible display 102, similar to how clay may be shaped using a spinning pottery wheel through centrifugal force applied to the clay through a user's hand while the clay is spinning.

As shown in FIG. 3A, a user can apply a virtual centrifugal force to the 3D digital object by rotating the object displayed on the flexible device, for example through a gesture or interaction with an interface of flexible display 102, shown in FIG. 3A as spinning of the user's finger 106 in a circle 107 within the selected area. Alternatively, the rotation speed may be manually entered into an interface of the flexible display.

As shown in FIG. 3B, as a virtual centrifugal force is applied to the selected area, the 3D object 104 is changed—in this example, by expanding the selected area 103 (i.e. the top of the turtle's shell) as a potter would expand a bowl on a potter's wheel. The speed of the rotation of the 3D digital object 104 by the user 106 or through input from the user through an interface of the flexible display 102 is directly related to the amount of centrifugal force to be applied to the specified area. The faster the rotating speed of the 3D digital object 104, the greater the centrifugal force applied to the selected area 105 and the greater distortion applied to the specified area. The rotating speed may be detected by sensors of the flexible display 102 or manually inputted by the user through an interface of the flexible display.

As shown in FIG. 3C, a second force may be applied to the 3D object 104 by bending the flexible display 102 to manipulate a portion of the object. In FIG. 3C, the user's finger 106 applies pressure to a corner 108 of the display 102, causing it to bend along a line 109.

The sensors of the flexible display 102 receive input regarding the bending stress and the direction of bending. When the direction in which the flexible display 102 is being bent is sensed, the bending program 66 of the device with the flexible display identifies an axis 109 along which the bending took place and can re-render an area of the digital representation of the 3D object 104 accordingly. In the example of FIG. 3C, a corner 110 the expanded area of the top of the turtle's shell 103 is bent downward, as would be indicated by the bending of the display 102 along line 109.

Once the alteration of the selected area 103 is complete, the user can select another area to alter.

It should be noted that while a flexible display device is used above to describe selection of a specific 3D object area to focus on and distortion and/or manipulation of the 3D object may be carried out on any display with sensors that can detect touch or pressure from a user.

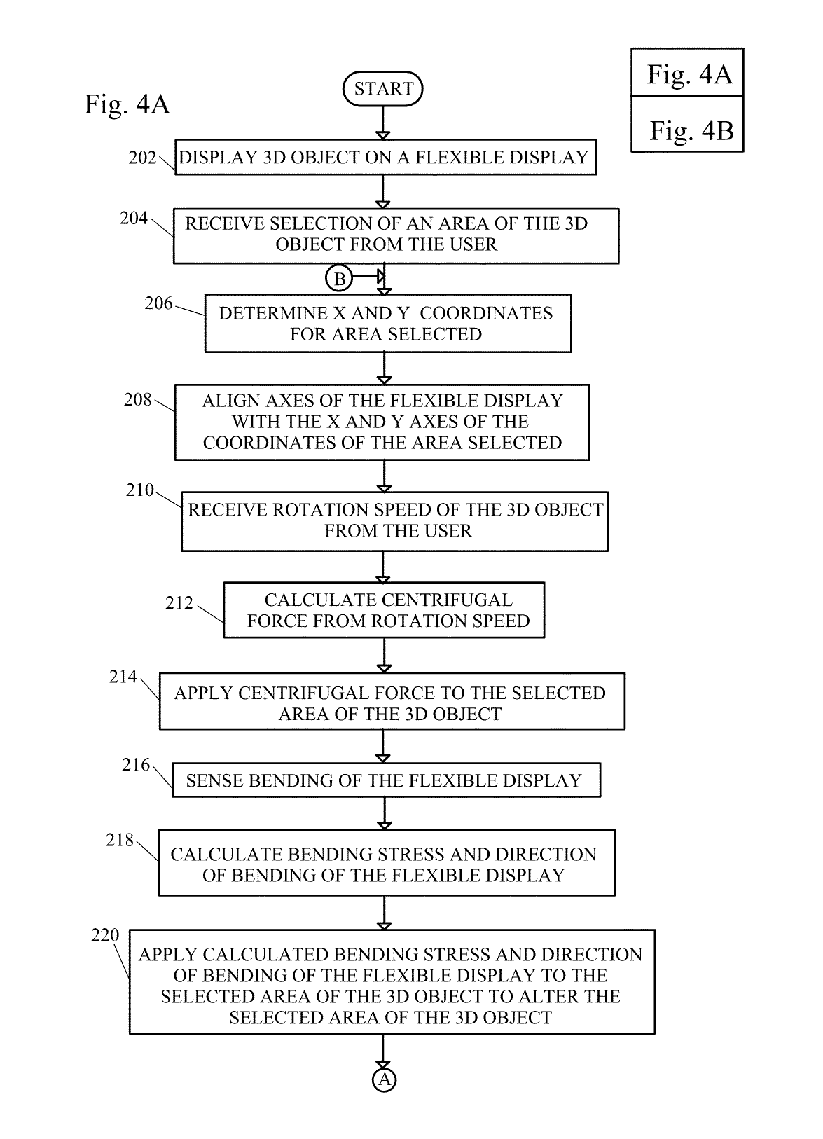

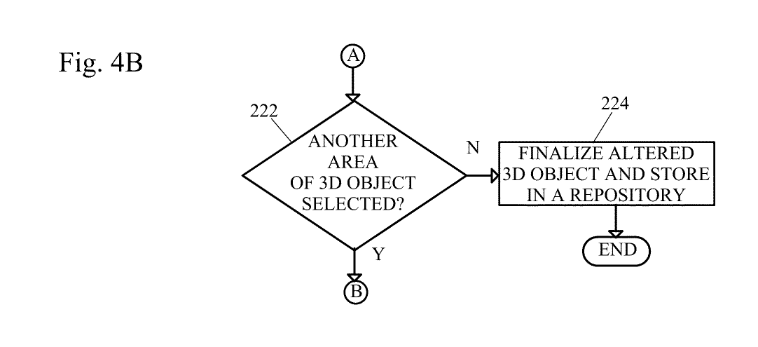

FIGS. 4A-4B show a flow diagram of a method of bending a digital representation of a 3D object on a display based on a user selected area of focus.

In a first step, a 3D object is displayed on a flexible display (step 202). The sensors of the flexible display detects a selection of an area of the 3D object from a user (step 204), for example by the bending program 66. The selection takes place through the flexible display. The X and Y coordinates of the 3D object are determined for the area selected by the user (step 206), for example by the bending program 66.

The X and Y axes of the flexible display are aligned with the X and Y axes of the X and Y coordinates determined for the area selected by the user (step 208), for example by the bending program 66.

A rotation speed of the 3D object from the user is received (step 210). The rotation speed may be generated from a speed in which a user is moving the selected area through an interface of the flexible display which is sensed by the sensors of the flexible display. Alternatively, the rotation speed may be manually entered by the user through an interface of the flexible display. A virtual centrifugal force is calculated from the rotation speed sensed (step 212), for example by the bending program 66.

The calculated virtual centrifugal force is applied as a distortion to the selected area of the 3D object (step 214), for example by the bending program.

Sensors of the flexible display detect bending or twisting of the flexible display (step 216), for example by the bending program 66. The bending stress and direction of the bending relative to the X and Y axes is calculated (step 218). The calculated bending stress and direction of the bending is applied to the selected area of the 3D object to alter the selected area of the 3D object (step 220), for example by the bending program 66.

If another area of the 3D object is selected by the user (step 222), the method returns to step 206 of determining the X and Y coordinates for the area selected.

If another area of the 3D object is not selected by the user (step 222), the 3D object is finalized and stored in a repository (step 224), for example repository 53 and the method ends.

FIG. 5 illustrates internal and external components of device computer 52 and server computer 54 in which illustrative embodiments may be implemented. In FIG. 5, device computer 52 and server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, bending program 66 is stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Bending program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Bending program 66 can be downloaded to the device computer 52 and server computer 54 from an external computer via a network (for example, the Internet, a local area network or other, wide area network) and network adapter or interface 836. From the network adapter or interface 836, bending program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Bending program 66 can be written in various programming languages including low-level, high-level, object-oriented or non object-oriented languages. Alternatively, the functions of a bending program 66 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method for manipulating a three dimensional object displayed on a display device having a plurality of sensors for sensing touching and distortion of the display device and a computer coupled to the plurality of sensors, the method comprising the steps of:
the computer detecting a selection of a specified area of the digital representation of a three dimensional object displayed on the display device through the plurality of sensors;
the computer determining X and Y coordinates of the selected specified area of the digital representation;
the computer aligning the axes of the display device with the X and Y coordinates of the selected specified area;
the computer receiving a rotation speed from a user;
the computer calculating a virtual centrifugal force associated with the received rotation speed;
the computer applying the virtual centrifugal force as a distortion to the selected specified area of the three dimensional object; and
the computer re-rendering the three dimensional object on the display device.

2. The method of claim 1, wherein the display device is a flexible display device.

3. The method of claim 2, the method further comprising the steps of:
the computer sensing bending of the flexible display device by the user from the plurality of sensors;
the computer calculating a direction and a stress associated with the sensed bending of the flexible display device;
the computer applying the direction and a stress associated with the sensed bending of the flexible display device as a distortion to the selected specified area of the three dimensional object; and
the computer re-rendering the three dimensional object on the flexible display.

4. The method of claim 1, wherein the rotation speed from the user is received through an interface of the display device.

5. The method of claim 1, wherein the rotation speed from the user is received on the display device by a user and detected by the plurality of sensors.

6. A computer program product for manipulating a three dimensional object displayed on a display device having a plurality of sensors for sensing touching and distortion of the display device and a computer coupled to the plurality of sensors comprising at least one processor, one or more memories, one or more computer readable storage media, the computer program product comprising a computer readable storage medium having program instructions embodied therewith, the program instructions executable by the computer to perform a method comprising:
detecting, by the computer, a selection of a specified area of the digital representation of a three dimensional object displayed on the display device through the plurality of sensors;
determining, by the computer, X and Y coordinates of the selected specified area of the digital representation;
aligning, by the computer, the axes of the display device with the X and Y coordinates of the selected specified area;
receiving, by the computer, a rotation speed from a user;
calculating, by the computer, a virtual centrifugal force associated with the received rotation speed;
applying, by the computer, the virtual centrifugal force as a distortion to the selected specified area of the three dimensional object; and
re-rendering, by the computer, the three dimensional object on the display device.

7. The computer program product of claim 6, wherein the display device is a flexible display device.

8. The computer program product of claim 7, the program instructions further comprising the steps of:
sensing, by the computer, bending of the flexible display device by the user from the plurality of sensors;
calculating, by the computer, a direction and a stress associated with the sensed bending of the flexible display device;
applying, by the computer, the direction and a stress associated with the sensed bending of the flexible display device as a distortion to the selected specified area of the three dimensional object; and
re-rendering, by the computer, the three dimensional object on the flexible display.

9. The computer program product of claim 6, wherein the rotation speed from the user is received, by the computer, through an interface of the display device.

10. The computer program product of claim 6, wherein the rotation speed from the user is received, by the computer, on the display device by a user and detected, by the computer, from the plurality of sensors.

11. A computer system for manipulating a three dimensional object displayed on a display device having a plurality of sensors for sensing touching and distortion of the display device and a computer coupled to the plurality of sensors comprising at least one processor, one or more memories, one or more computer readable storage media having program instructions executable by the computer to perform the program instructions comprising:
determining, by the computer, X and Y coordinates of the selected specified area of the digital representation;
aligning, by the computer, the axes of the display device with the X and Y coordinates of the selected specified area;
receiving, by the computer, a rotation speed from a user;
calculating, by the computer, a virtual centrifugal force associated with the received rotation speed;
applying, by the computer, the virtual centrifugal force as a distortion to the selected specified area of the three dimensional object; and
re-rendering, by the computer, the three dimensional object on the display device.

12. The computer system of claim 11, wherein the display device is a flexible display device.

13. The computer system of claim 12, the program instructions further comprising the steps of:
sensing, by the computer, bending of the flexible display device by the user from the plurality of sensors;
calculating, by the computer, a direction and a stress associated with the sensed bending of the flexible display device;
applying, by the computer, the direction and a stress associated with the sensed bending of the flexible display device as a distortion to the selected specified area of the three dimensional object; and
re-rendering, by the computer, the three dimensional object on the flexible display device.

14. The computer system of claim 11, wherein the rotation speed from the user is received, by the computer, through an interface of the display device.

15. The computer system of claim 11, wherein the rotation speed from the user is received, by the computer, on the display device by a user and detected, by the computer, from the plurality of sensors
